(19) United States
(12) Patent Application Publication
(10) Pub. No.: US 2026/0036976 A1
(43) Pub. Date: Feb. 5, 2026

(54) ROOT-CAUSE ANALYSIS AND REMEDIATION OF AIR-GAPPED INDUSTRIAL SYSTEMS

(71) Applicant: Kyndryl, Inc., New York, NY (US)

(72) Inventors: Avneesh Balyan, New Albany, OH (US); Manish Gupta, New Delhi (IN); Rajeev Puri, Huntersville, NC (US); Nadeem Dr. Malik, Austin, TX (US); Manbir Singh, Northville, MI (US)

(21) Appl. No.: 18/789,908

(22) Filed: Jul. 31, 2024

(51) Int. Cl. G05B 23/02

(52) U.S. Cl. CPC G05B 23/0275

(57) ABSTRACT

Examples described herein provide a method that includes receiving a set of air-gapped systems' states from a plurality of monitored air-gapped systems. The method further includes aggregating one or more subsets of the set of air-gapped systems' states based on a vectorized set of standard operating procedures in execution at a time of the generating. The method further includes determining, using at least one aggregation, an intersystem state event dependency defining the aggregating using natural language processing techniques. The method further includes forwarding the intersystem state event dependency to a secondary event aggregator. The method further includes classifying the intersystem state event dependency as an abnormal intersystem state event dependency. The method further includes determining, based on a historical corpus of intersystem state event dependencies, a resolution for the abnormal intersystem state event dependency. The method further includes implementing the resolution to resolve the abnormal interstate system state event dependency.

### BACKGROUND

The present disclosure relates to computing environments, and more specifically, to using generative artificial intelligence for root-cause analysis and remediation of air-gapped systems in industrial and energy systems.

Generative artificial intelligence is artificial intelligence (AI) capable of generating text, images, or other media, using generative models. Generative AI models learn the patterns and structure of their input training data and then generate new data that has similar characteristics. Advances in transformer-based deep neural networks have enabled a number of generative AI systems notable for accepting natural language prompts as input. These include large language model (LLM) chatbots by various organizations.

### SUMMARY

According to an embodiment, a computer-implemented method for managing air-gapped systems is provided. The method includes receiving a set of air-gapped systems' states from a plurality of monitored air-gapped systems, the monitoring performed by a set of visual capture devices capable of visualizing one or more consoles associated with the plurality of monitored air-gapped systems. The method further includes aggregating one or more subsets of the set of air-gapped systems' states based on a vectorized set of standard operating procedures in execution at a time of the generating. The method further includes determining, using at least one aggregation, an intersystem state event dependency defining the aggregating using natural language processing techniques. The method further includes forwarding the intersystem state event dependency to a secondary event aggregator. The method further includes classifying the intersystem state event dependency as an abnormal intersystem state event dependency. The method further includes determining, based on a historical corpus of intersystem state event dependencies, a resolution for the abnormal intersystem state event dependency. The method further includes implementing the resolution to resolve the abnormal interstate system state event dependency.

Other embodiments described herein implement features of the above-described method in computer systems and computer program products.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of one or more embodiments described herein are apparent from the following detailed description taken in conjunction with the accompanying drawings in which:

FIG. 1 depicts a block diagram of an example computer system for use in conjunction with one or more embodiments described herein;

FIG. 2 depicts a system having multiple sub-systems and components, including an air-gapped subsystem according to one or more embodiments;

FIG. 3 shows details of the system and the subsystem of FIG. 2 according to one or more embodiments;

FIG. 4 illustrates a flow diagram of a method for managing air-gapped systems according to one or more embodiments;

FIG. 5 depicts a flow diagram of a method for generating an event summary according to one or more embodiments;

FIG. 6 depicts a flow diagram of a method for defining event tags and storing incoming data according to one or more embodiments;

FIG. 7 depicts a flow diagram of a method for correlating and generating a prompt according to one or more embodiments;

FIG. 8 depicts a flow diagram of a method for automatic prompt creation according to one or more embodiments;

FIG. 9 depicts a cloud computing environment according to one or more embodiments; and

FIG. 10 depicts abstraction model layers according to one or more embodiments.

The detailed description explains embodiments of the disclosure, together with advantages and features, by way of example with reference to the drawings.

### DETAILED DESCRIPTION

One or more embodiments described herein provide for using general artificial intelligence for root-cause analysis and remediation of air-gapped systems in industrial and energy systems.

Descriptions of various embodiments of the present disclosure are presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

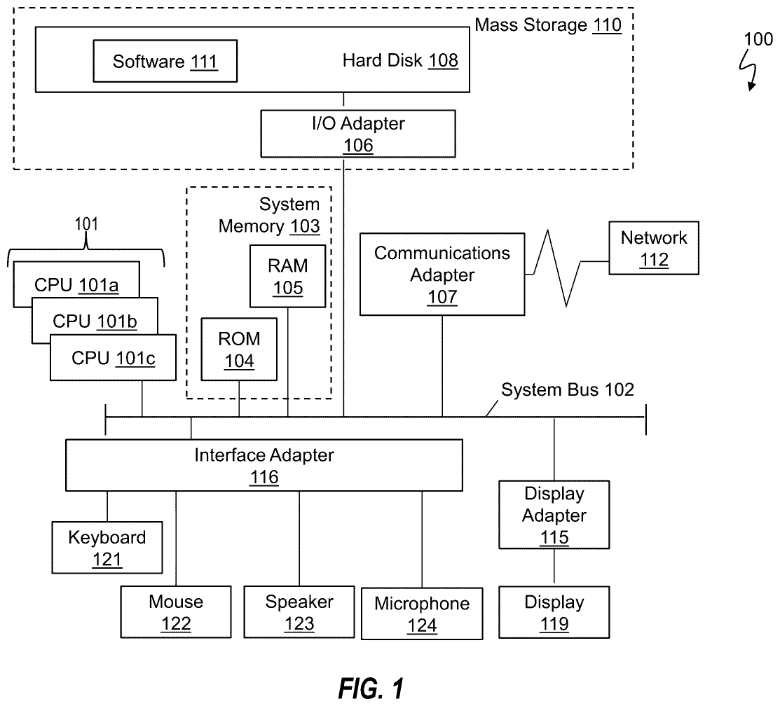

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction are discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

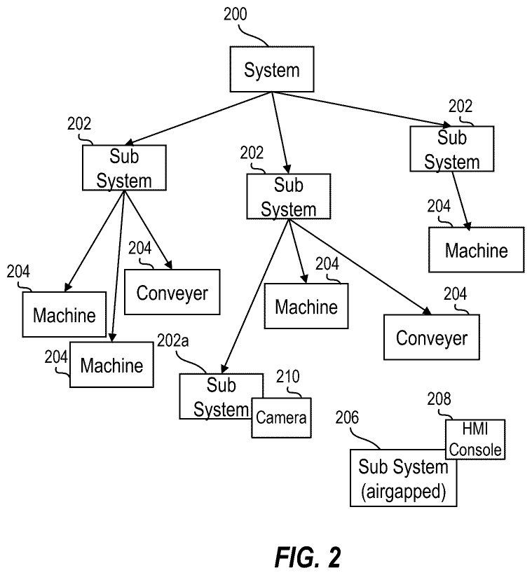

In some environments, equipment can exist in an air-gapped environment. For example, FIG. 2 depicts a system 200 having multiple sub-systems 202 and components 204, including an air-gapped subsystem 206. An air-gapped environment refers to a network or system (e.g., a computer, machinery) that is physically isolated from any other networks, particularly the internet. For example, in FIG. 2, each of the sub-systems 202 and components 204 are connected via communication link(s) to the system 200 (directly or indirectly) as shown by the arrows. However, the air-gapped subsystem 206 is not connected directly or indirectly to the system 200. This isolation is used to enhance security of the air-gapped subsystem 206 and the system 200, ensuring that sensitive data and critical systems are protected from external threats such as hacking, malicious software (“malware”), and data breaches. For example, equipment (including systems and/or subsystems) in the industrial and energy sectors often exist in air-gapped environments. Such equipment cannot be controlled or monitored remotely by directly interfacing with the equipment since it is air gapped. Instead, to understand the health of air gapped equipment and/or to directly interact with such equipment, a skilled and trained operator directly interacts with the equipment (e.g., the air-gapped subsystem 206) using a human machine interface (HMI) console 208 for the equipment. The HMI console can display information about the equipment and provide for the operator inputs to the equipment. In some cases, the HMI console provides for the operator to perform troubleshooting assessment and root cause analysis of the equipment. These manual processes are done for each piece of equipment (system and/or subsystem) in scope to create a larger picture of an entire system (operations). This process is time consuming to create and/or update and prone to error (e.g., incorrect information entered).

One or more embodiments described herein address these and other shortcomings by using cameras to capture information on the HMI console of the equipment, which provides for indirect remote monitoring. In FIG. 2, the subsystem 202a can include a camera 210, which can be positioned and oriented to capture the HMI console 208 of the air-gapped subsystem 206. The camera 210 can capture the real-time video stream of the HMI console 208 either with an overlay camera networks (e.g., a mounted camera and/or wearable device) and/or by pushing the media packets through a data diode providing only one-way communication to the system 200. The real-time videos/images are analyzed by an industrial domain specific vision-based large language model (LLM) fine-tuned for HMI image analysis. Along with providing the status of the air-gapped subsystem 206 in human linguistic format, a generative artificial intelligence system (e.g., an LLM with a retrieval-augmented generation (also known as ‘RAG’) and industrial information) is implemented to correlate events within the same vertical or with other verticals. A knowledge base of standard operating procedures (SOPs) and other operating manuals (e.g., equipment manuals, assembly manuals, etc.) aid in providing actionable insights to individuals at a location of the air-gapped subsystem 206 (e.g., a manufacturing floor) to optimize operations. It should be appreciated that, although only one air-gapped subsystem 206 is shown, multiple air-gapped subsystems may be implemented according to one or more embodiments. It should also be appreciated that the air-gapped subsystem 206 can represent any system, subsystem, device, component, and/or the like, including combinations and/or multiples thereof, that is air gapped relative to the system 200.

As will be further described herein, the system 200 provides a generative artificial intelligence-based alerting, root-cause analysis, and remediation of air-gapped systems, such as in manufacturing and energy systems. The system 200 generates events from air-gapped sub-systems that expose a state using information imaged from an HMI console. The state of a subsystem is estimated by use of camera (e.g., the camera 210) that captures the HMI console 208 that is used to generate the events. The system 200 aggregates events from other air-gapped subsystems according to one or more embodiments using vectorize SOPs from other subsystems whose events are aggregated at the system 200. The system 200 defines interevent dependency in natural language. According to one or more embodiments, the system 200 forwards aggregated event summary to a higher level event aggregator and uses a data diode to provide one way communication while preserving the “air-gappedness” of the system.

According to one or more embodiments, the system 200 provides rapid generation of an event summary for a video/image from an HMI console of an air-gapped system using video/image embedding clustering. To do this, the system 200 automatically classifies information (e.g., images) from the HMI console 208 as being normal or abnormal, analyzes each cluster of abnormal states to automatically generate event summaries for that cluster based on the abnormal state, and uses a vision-based LLM to validate and update the event summary for individual images/videos. More particularly, when wrong states (e.g., anomalies) are observed, the states are recorded as events in a database, and a summary of what the problem is (e.g., the anomaly) can be generated. According to one or more embodiments, events can have tags associated therewith, and the tags can be used to cluster events that are the same or similar.

According to one or more embodiments, the system 200 provides for automatic LLM prompt generation that leverages historical event information for an air-gapped subsystem that is used to generate a query to perform retrieval-augmented generation (RAG) on a corpus of SOPs.

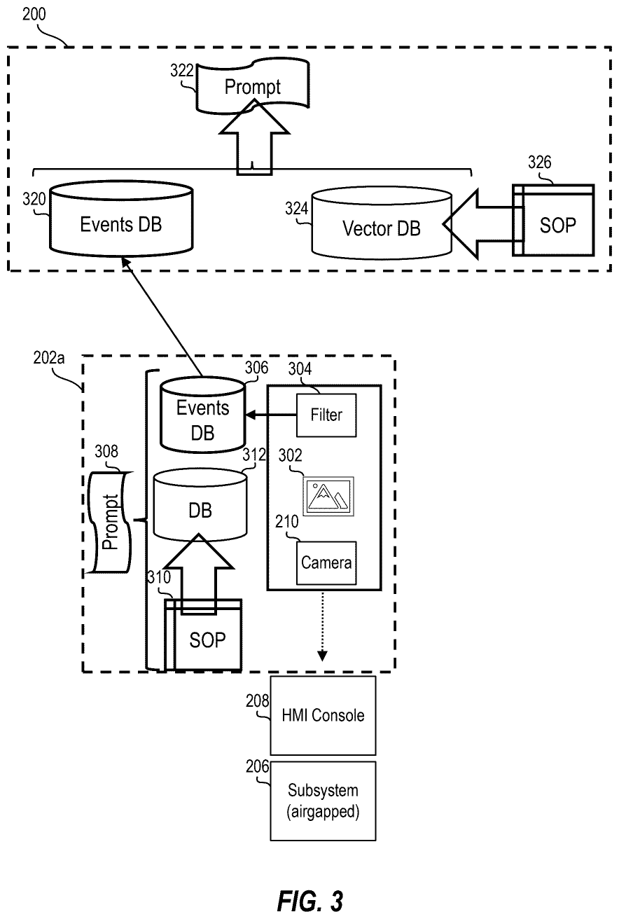

FIG. 3 shows details of the system 200 and the subsystem 202a, according to one or more embodiments. In this embodiment, the subsystem 202a captures image data 302 using the camera 210. The image data 302 can be one or more of still images, video data, frames extracted from video data, and/or the like, including combinations and/or multiples thereof. The subsystem 202a applies a filter 304 to filter out good states of the air-gapped subsystem 206. Good states are those states of operation of the air-gapped subsystem 206 that are known not to be anomalous (e.g., the air-gapped subsystem 206 is operating nominally). Subsequent to applying the filter 304, images of anomalous states/events are sent to the events database (DB) 306 and stored as an event summary. According to one or more embodiments, a local prompt 308 is generated at the subsystem 202a using at least the events stored in the event DB 306. The local prompt 308 is a text-based summary of the problem localization, insights, and remedies for the air-gapped subsystem 206. The local prompt 308 can be generated using machine learning techniques as are further described herein. The local prompt also uses SOP information 310 stored in a local DB 312. The SOP information 310 is information about the standard operating procedures for the air-gapped subsystem 206 (e.g., operating manuals, installation guides, and/or the like, including combinations and/or multiples thereof).

The events stored in the event DB 306 are also stored in an events DB 320 of the system 200 along with events from other sources (e.g., other subsystems 202 and/or components 204 of FIG. 2). In this regard, the events DB 320 is an aggregated events DB. Using the aggregated events information from various sources stored in the events DB 320, the system 200 can generate a global prompt 322 in much the same way that the local prompt 308 was created. According to one or more embodiments, the system 200 generates the global prompt 322 by generating a query using information stored in the events DB 320. That is, the system 200 automatically generates the query for RAG. The query is used to generate the global prompt 322 along with context information stored in a vector DB 324. The context information is created using embeddings generated from SOP information 326 for various subsystems (e.g., operating manuals, installation guides, and/or the like, including combinations and/or multiples thereof). The embeddings can be created using natural language intersystem dependencies, for example. It should be appreciated that, although one subsystem 202a is shown as sending event information to the system 200, multiple subsystems can send event information for various air-gapped subsystems to the system 200.

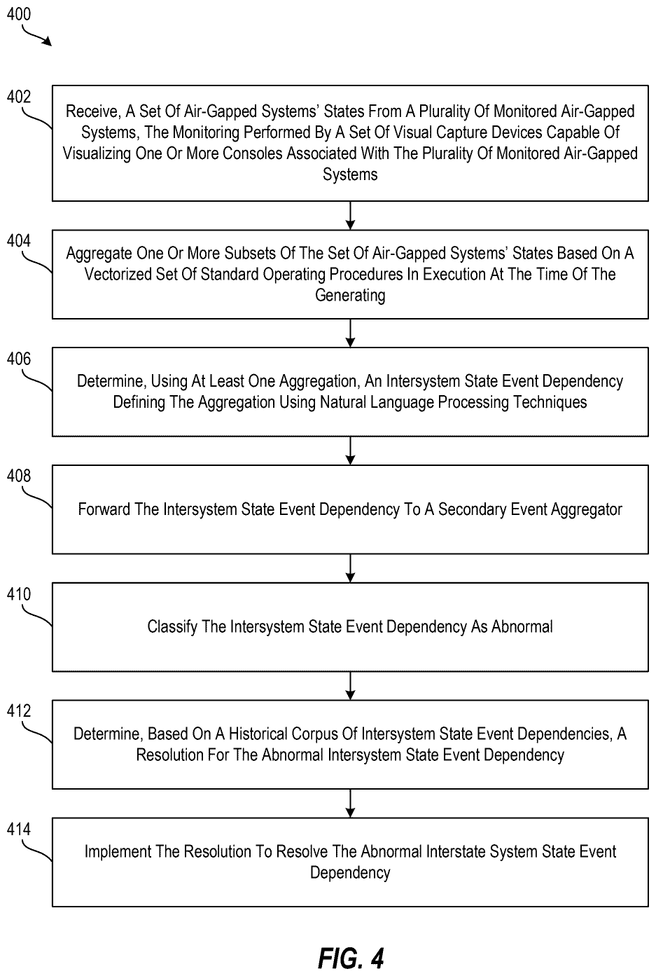

Turning now to FIG. 4, a method 400 for managing air-gapped systems is described, according to an embodiment. The method 400 can be performed by any suitable computing system, device, or environment, such as those described herein. The method 400 is now described with reference to the system 200 of FIGS. 2 and 3 but is not so limited. According to one or more embodiments, the system 200 be the computing system 100 of FIG. 1 and/or can include one or more components of the computing system 100.

At block 402, the subsystem 202a receives a set of air-gapped systems' states from a plurality of monitored air-gapped systems (e.g., the air-gapped subsystem 206), the monitoring performed by a set of visual capture devices (e.g., the camera 210) capable of visualizing one or more consoles (e.g., the HMI console 208) associated with the plurality of monitored air-gapped systems. The set of air-gapped systems' states are generated by respective subsystems (e.g., the subsystem 202a). For example, the subsystem 202a determines event information as described herein and sends the event information to the system 200 (e.g., to the events DB 320).

At block 404, the subsystem 202a aggregates one or more subsets of the set of air-gapped systems' states based on a vectorized set of standard operating procedures in execution at the time of the generating. The vectorized set of SOPs are the SOP(s) 310 vectorized and stored in the local DB 312, for example.

At block 406, the subsystem 202a determines, using at least one aggregation of the one or more subsets of the set of air-gapped systems' states, an intersystem state event dependency defining the aggregation using natural language processing techniques. An intersystem state event dependency is a manifestation of functional dependencies of multiple systems and/or subsystems. For example, if a first subsystem produces a box and sends that box to a second subsystem to fill the box, the failure of the first subsystem impacts the performance of the second subsystem According to one or more embodiments, the subsystem 202a uses a large language model to determine the intersystem state event dependency defining the aggregation.

At block 408, the subsystem 202a forwards the intersystem state event dependency to a secondary event aggregator (e.g., the system 200). According to one or more embodiments, this is performed using a data diode to preserve the air-gapped nature of the air-gapped systems.

At block 410, the system 200 classifies the intersystem state event dependency as abnormal. For example, the intersystem state event dependency is compared with other information (e.g., other intersystem state event dependencies) stored in the events DB 320 for other air-gapped subsystems.

At block 412, the system 200 determines, based on a historical corpus of intersystem state event dependencies (e.g., stored in the vector DB 324), a resolution for the abnormal intersystem state event dependency. According to one or more embodiments, if resolution for the abnormal intersystem state event dependency cannot be determined, the method 400 includes localizing, using the set of visual capture devices (e.g., the camera 210), one or more root-cause subsystems of the set of air-gapped systems and notifying one or more users of the locality of the one or more root-cause subsystems. Localizing refers to determining the root cause of the problem observed at the system or subsystem. For example, in a scenario where a second subsystem is dependent on a first subsystem and a problem event of low throughput is observed at the second subsystem, a dependency graph identifies the root cause as being the first subsystem where the actual problem, as determined through localization, is the low throughput at the first subsystem (or another failure in the pipeline), not the second subsystem itself. According to one or more embodiments, the notifying can include sending a message/alert with the prompt, including a proposed corrective action to remedy the anomalous state. According to one or more embodiments, to preserve the air-gapped nature of the air-gapped subsystem 206, the system 200 can generate an audible alert in proximity to the air-gapped subsystem 206 so that a nearby operator or technician is alerted.

At block 414, the system 200 implements the resolution to resolve the abnormal interstate system state event dependency. According to one or more embodiments, a resolution (or “corrective action”) can include causing a device or component of the system 200 to correct the anomalous state of the air-gapped subsystem 206. For example, a robot can be controlled by the system 200 to move in proximity to the air-gapped subsystem 206 and perform some action (e.g., adjust a setting, replace a broken component, and/or the like, including combinations and/or multiples thereof) of the air-gapped subsystem 206. This provides for correcting the anomalous state while preserving the air-gapped nature of the air-gapped subsystem 206. According to one or more embodiments, if the intersystem state event dependency is classified as normal, a user can be notified of the normal intersystem state event dependency.

Additional processes also may be included, and it should be understood that the processes depicted in FIG. 4 represent illustrations, and that other processes may be added or existing processes may be removed, modified, or rearranged without departing from the scope of the present disclosure. It should also be understood that the processes depicted in FIG. 4 may be implemented as programmatic instructions stored on a non-transitory computer-readable storage medium that, when executed by a processor (e.g., the processor(s) 101 of FIG. 1) of a computing system (e.g., the computer system 100 of FIG. 1), cause the processor to perform the processes described herein.

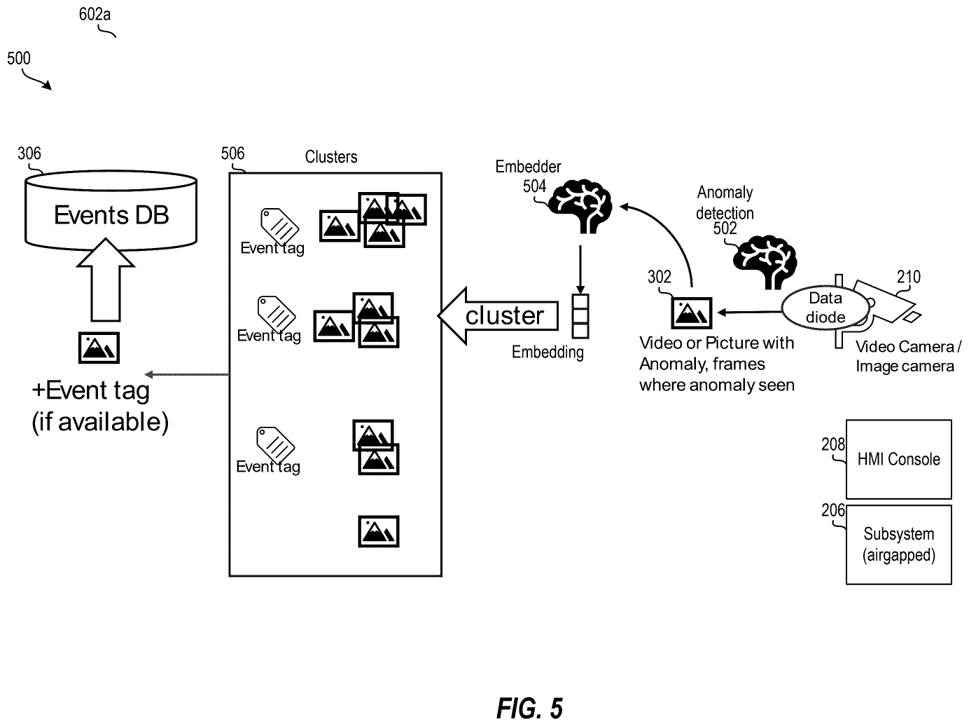

FIG. 5 depicts a flow diagram of a method 500 for generating an event summary according to one or more embodiments. The method 500 can be performed by any suitable computing system, device, or environment, such as those described herein. The method 500 is now described with reference to the system 200 of FIGS. 2 and 3 but is not so limited. According to one or more embodiments, the system 200 be the computing system 100 of FIG. 1 and/or can include one or more components of the computing system 100.

The camera 210 is used to capture the HMI console 208 for the air-gapped subsystem 206 as image(s)/video(s). A data diode 501 is used to preserve the air-gapped nature of the air-gapped subsystem 206. The data diode 501 provides for sending information one way only. An anomaly detection model 502 is trained to perform state recognition to detect nominal and abnormal states of the air-gapped subsystem 206 using the image(s)/video(s) captured by the camera 210 of the HMI console 208. Any deviation from the nominal state implies that the image(s)/video(s) show an abnormal state, in which case the image(s)/video(s) are passed to an embedder 504 for embedding and further analysis. Otherwise, image(s)/video(s) showing nominal states are filtered out as described herein. When the state of the air-gapped subsystem 206 returns to nominal from abnormal, the event is sent to the events DB 306.

In the case of abnormal states, an embedder 504 performs embedding on the image(s)/video(s). For example, the embedder 504 encodes an input and generates a multi-dimensional vector which is a real number. The embeddings are then used to generate a cluster and/or add an image to an existing cluster of the clusters 506. For a latest/next image or video, it is determined to which cluster of the clusters 506 the image or video should be associated. Based on the cluster, a potential description (e.g., an event tag) of the anomalous event is predicted/generated. The event tag associated with each cluster of the clusters 506 describes potential events describing the anomalous state with an associated estimated probability. If the latest image/video differs from existing clusters of the clusters 506, a new cluster can be created by composing an event tag. This may be performed, for example, based on a closest k cluster. According to one or more embodiments, at the clusters 506, tags are computed whenever changes occur to clustering or descriptions of events. The image(s)/video(s) can then be saved to the events DB 306 along with the event tag (if desired). The event tag serves as the “event summary” of the event. A non-limiting example of an event tag (e.g., event summary) is: “The pipe number 10 is showing pressure of 12.5 and growing at a rate of 0.01/min [support: 90%, size: 9, timestamp: t1].” Another non-limiting example of an event tag (e.g., event summary) is: “The pipe number 11 is showing pressure of 11 and growing at a rate of 0.01/min [support: 10%, size: 1, timestamp: t1].”

Additional processes also may be included, and it should be understood that the processes depicted in FIG. 5 represent illustrations, and that other processes may be added or existing processes may be removed, modified, or rearranged without departing from the scope of the present disclosure. It should also be understood that the processes depicted in FIG. 5 may be implemented as programmatic instructions stored on a non-transitory computer-readable storage medium that, when executed by a processor (e.g., the processor(s) 101 of FIG. 1) of a computing system (e.g., the computer system 100 of FIG. 1), cause the processor to perform the processes described herein.

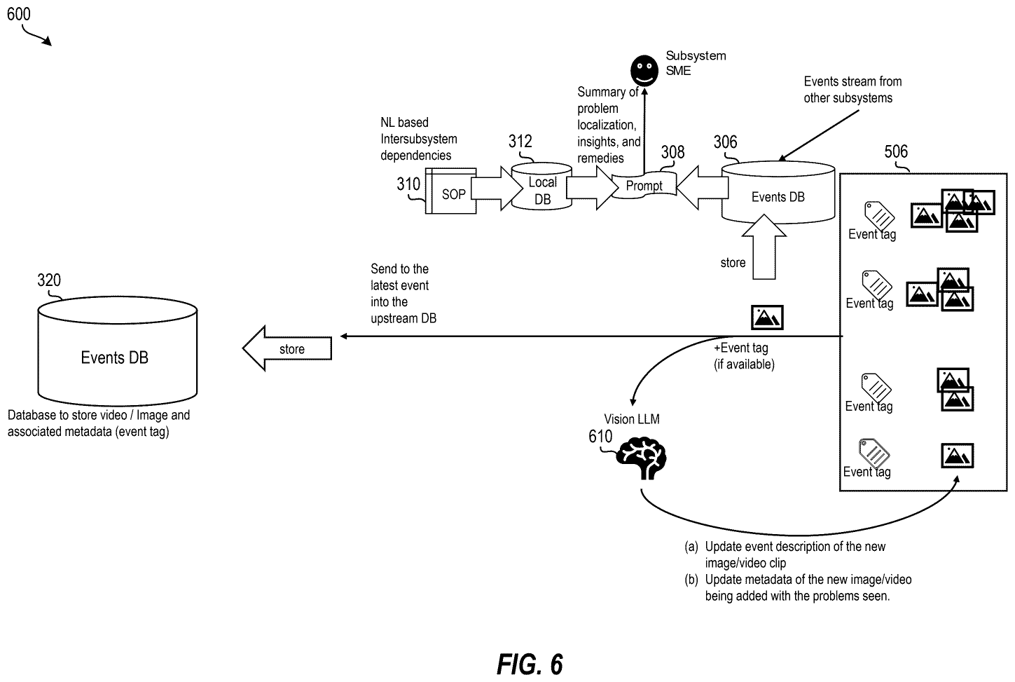

FIG. 6 depicts a flow diagram of a method 600 for defining event tags and storing incoming data according to one or more embodiments. The method 600 can be performed by any suitable computing system, device, or environment, such as those described herein. The method 600 is now described with reference to the system 200 of FIGS. 2 and 3 but is not so limited. According to one or more embodiments, the system 200 be the computing system 100 of FIG. 1 and/or can include one or more components of the computing system 100.

In this example, when a new event occurs (e.g., a newly detected anomalous state of the air-gapped subsystem 206), the image and event tag (if applicable) is sent to a vision-based LLM 610. The vision-based LLM 610 updates an event description of the new image/video and updates metadata for the new image/video being added with the problem(s)/anomaly(ies) shown in the image/video. That is, the event description and metadata for the cluster of the clusters 506 are updated. The new image/video and event tag (if applicable) is also stored into the events DB 306, which is used to generate the local prompt 308 along with the SOP information 310 stored in the local DB 312. The local prompt 308 provides a summary of problem localization, insights, and remedies to a subject matter expert (SME) for the air-gapped subsystem 206. The new image/video and event tag (if applicable) is also stored in the events DB 320, where it can be aggregated with events from other systems/subsystems.

Additional processes also may be included, and it should be understood that the processes depicted in FIG. 6 represent illustrations, and that other processes may be added or existing processes may be removed, modified, or rearranged without departing from the scope of the present disclosure. It should also be understood that the processes depicted in FIG. 6 may be implemented as programmatic instructions stored on a non-transitory computer-readable storage medium that, when executed by a processor (e.g., the processor(s) 101 of FIG. 1) of a computing system (e.g., the computer system 100 of FIG. 1), cause the processor to perform the processes described herein.

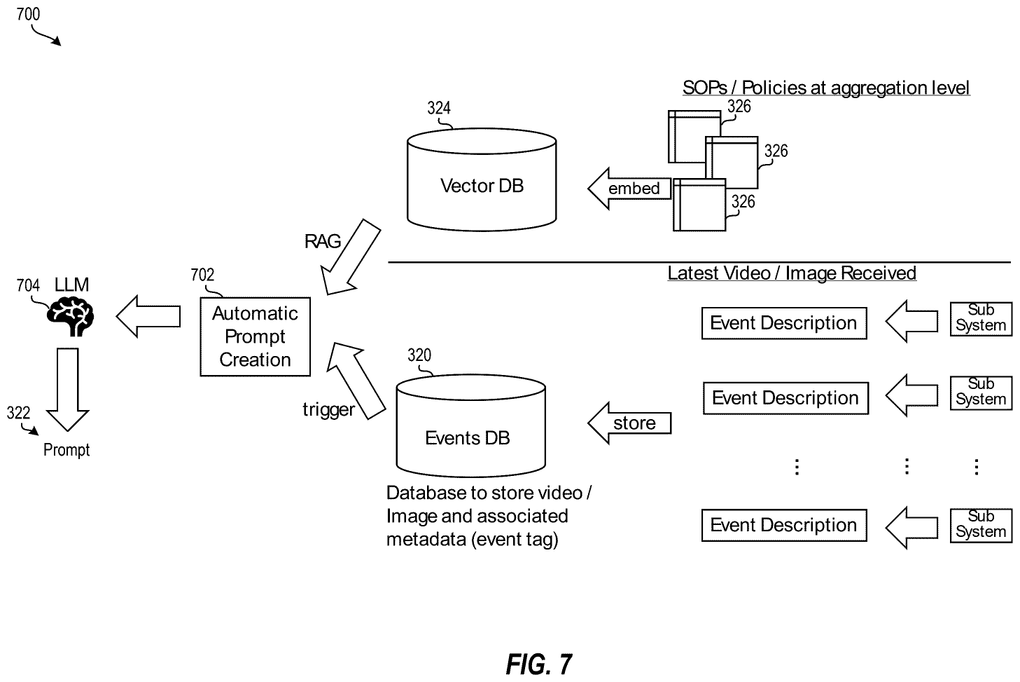

FIG. 7 depicts a flow diagram of a method 700 for correlating and generating a prompt (e.g., the global prompt 322) according to one or more embodiments. The method 700 can be performed by any suitable computing system, device, or environment, such as those described herein. The method 700 is now described with reference to the system 200 of FIGS. 2 and 3 but is not so limited. According to one or more embodiments, the system 200 be the computing system 100 of FIG. 1 and/or can include one or more components of the computing system 100.

The method 700 may be trigged, for example, whenever a new event occurs, to automatically compose a prompt (e.g., the global prompt 322) at the system level (e.g., the system 200). As described herein, the vector DB 324 stores SOP information 326, which may include maintenance manuals, equipment instructions, regulatory/compliance information, intersubsystem dependencies, and/or the like, including combinations and/or multiples thereof. The vector DB 324 may store the SOP information 326 as embeddings as described herein.

When a new image/video is received, an event description (e.g., tag) is generated and stored in the events DB 320 as described herein.

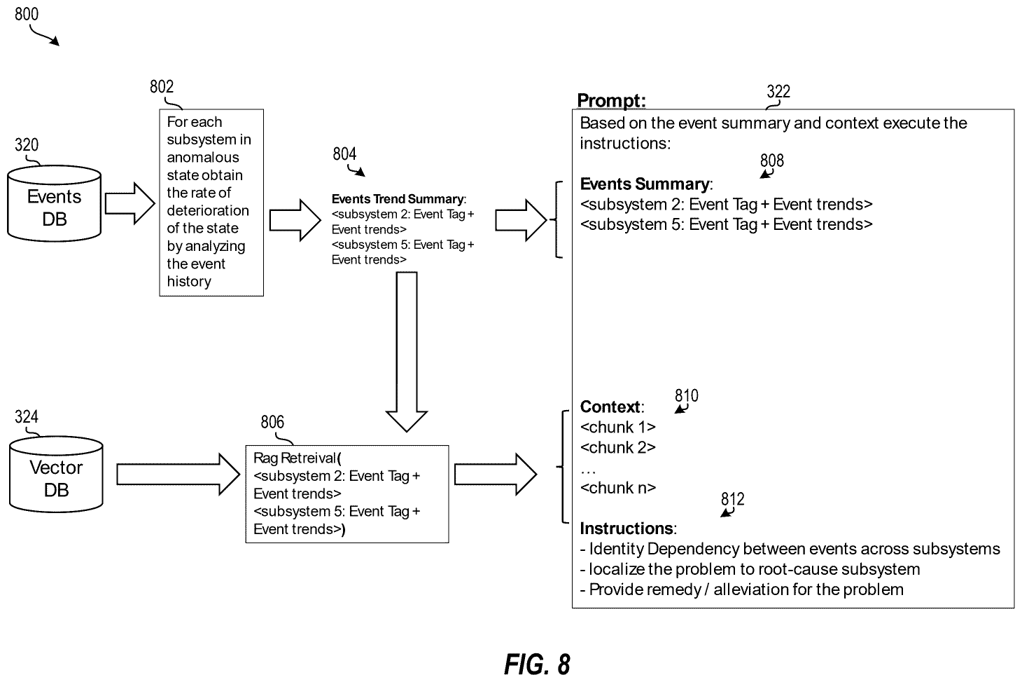

Using information stored in the events DB 320 and the vector DB 324, the system 200 can perform automatic prompt creation 702 to generate the global prompt 322. The automatic prompt creation 702 can be triggered, for example, when a new event is detected. The automatic prompt creation 702 can implement retrieval-augmented generation of the corpus of SOPs (e.g., the SOP information 326) stored in the vector DB 324. The automatic prompt creation 702 uses an LLM 704 to generate the global prompt 322 using the information stored in the events DB 320 and/or the information stored in the vector DB 324. The global prompt 322 serves as an explanation of the anomaly/event. Automatic prompt creation 702 is now described in more detail with reference to FIG. 8.

Additional processes also may be included, and it should be understood that the processes depicted in FIG. 7 represent illustrations, and that other processes may be added or existing processes may be removed, modified, or rearranged without departing from the scope of the present disclosure. It should also be understood that the processes depicted in FIG. 7 may be implemented as programmatic instructions stored on a non-transitory computer-readable storage medium that, when executed by a processor (e.g., the processor(s) 101 of FIG. 1) of a computing system (e.g., the computer system 100 of FIG. 1), cause the processor to perform the processes described herein.

In particular, FIG. 8 depicts a flow diagram of a method 800 for automatic prompt creation 702 according to one or more embodiments. The method 800 can be performed by any suitable computing system, device, or environment, such as those described herein. The method 800 is now described with reference to the system 200 of FIGS. 2 and 3 but is not so limited. According to one or more embodiments, the system 200 be the computing system 100 of FIG. 1 and/or can include one or more components of the computing system 100.

The automatic prompt creation 702 proceeds as follows. At block 802, for each subsystem in an anomalous state (e.g., the air-gapped subsystem 206a), a rate of deterioration of the state is obtained or determined by analyzing the event history in the events DB 320. For example, it is determined whether the anomalous state is worsening (deteriorating) looking at temporal information about the air-gapped subsystem 206a. As a result, an events trend summary 804 is generated, which includes events trends for each subsystem and each tag. The events trend summary 804 is incorporated with RAG retrieval information 806 generated from the vector DB 324, and results of this incorporation are used, along with the events trend summary 804, to generate the global prompt 322. The global prompt 322 includes the events summary information 808 taken from the events trend summary 804, content information 810 taken from the RAG retrieval information 806, and instructions 812. The instructions 812 can indicate a corrective action to take to remedy the anomaly and/or can advise whether a corrective action was implemented automatically to remedy the anomaly.

Additional processes also may be included, and it should be understood that the processes depicted in FIG. 8 represent illustrations, and that other processes may be added or existing processes may be removed, modified, or rearranged without departing from the scope of the present disclosure. It should also be understood that the processes depicted in FIG. 8 may be implemented as programmatic instructions stored on a non-transitory computer-readable storage medium that, when executed by a processor (e.g., the processor(s) 101 of FIG. 1) of a computing system (e.g., the computer system 100 of FIG. 1), cause the processor to perform the processes described herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

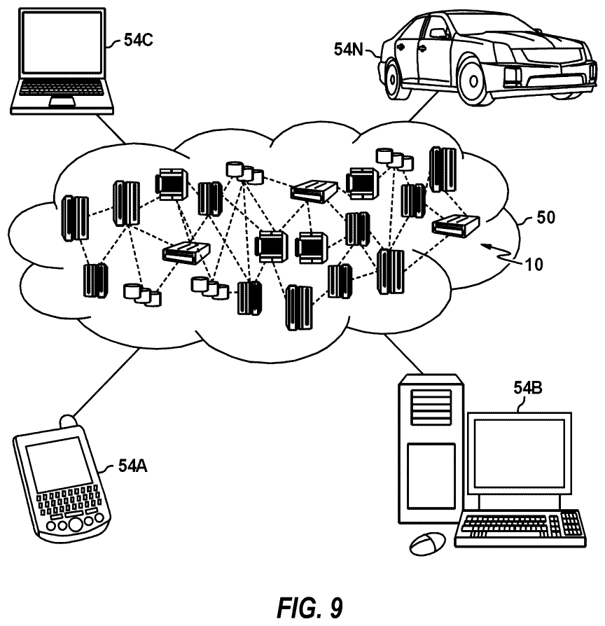

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

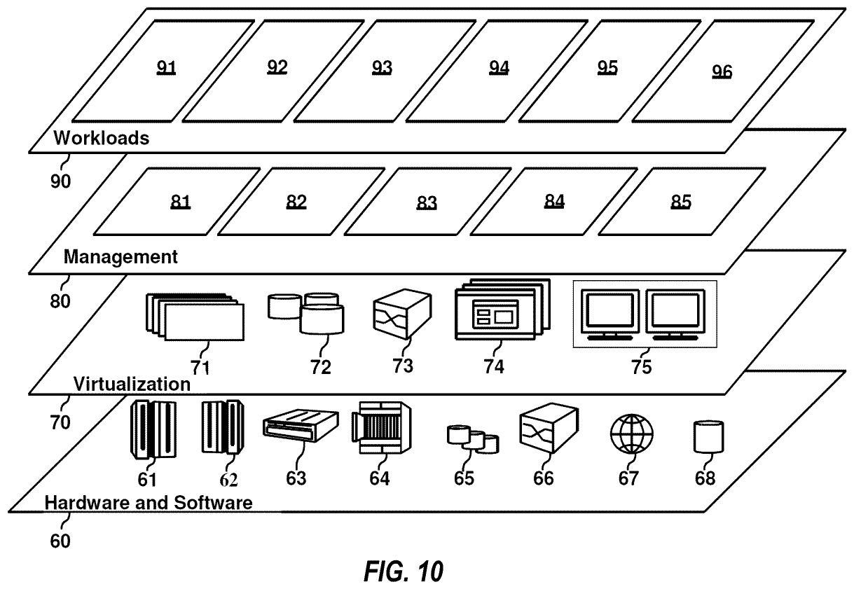

Referring now to FIG. 10, a set of functional abstraction layers provided by cloud computing environment 50 (depicted in FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and generative artificial intelligence for root-cause analysis and remediation of air-gapped systems in industrial and energy systems 96.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for managing air-gapped systems, the method comprising:
receiving a set of air-gapped systems' states from a plurality of monitored air-gapped systems, the monitoring performed by a set of visual capture devices capable of visualizing one or more consoles associated with the plurality of monitored air-gapped systems;
aggregating one or more subsets of the set of air-gapped systems' states based on a vectorized set of standard operating procedures in execution at a time of the generating;
determining, using at least one aggregation, an intersystem state event dependency defining the aggregating using natural language processing techniques;
forwarding the intersystem state event dependency to a secondary event aggregator;
classifying the intersystem state event dependency as an abnormal intersystem state event dependency;
determining, based on a historical corpus of intersystem state event dependencies, a resolution for the abnormal intersystem state event dependency; and
implementing the resolution to resolve the abnormal interstate system state event dependency.

2. The computer-implemented method of claim 1, wherein the intersystem state event dependency is classified as normal, further comprising notifying a user of a normal intersystem state event dependency.

3. The computer-implemented method of claim 1, wherein the resolution for the abnormal intersystem state event dependency cannot be determined, further comprising:
localizing, using the set of visual capture devices, one or more root-cause subsystems of the plurality of monitored air-gapped systems; and
notifying one or more users of a locality of the one or more root-cause subsystems.

4. The computer-implemented method of claim 1, wherein the forwarding is performed using a data diode to preserve an air-gapped nature of the air-gapped systems.

5. The computer-implemented method of claim 1, further comprising generating a prompt using a large language model, the prompted based at least in part on the intersystem state event dependency and the historical corpus of intersystem state event dependencies.

6. The computer-implemented method of claim 5, wherein the prompt is based at least in part on an events trend summary and a results of a retrieval-augmented generation operation.

7. The computer-implemented method of claim 1, further comprising clustering the intersystem state event dependency into one of a plurality of clusters, and generating event tags associated with the plurality of clusters.

8. A system comprising:
a memory comprising computer readable instructions; and
a processing device for executing the computer readable instructions, the computer readable instructions controlling the processing device to perform operations for managing air-gapped systems, the operations comprising:
receiving a set of air-gapped systems' states from a plurality of monitored air-gapped systems, the monitoring performed by a set of visual capture devices capable of visualizing one or more consoles associated with the plurality of monitored air-gapped systems;
aggregating one or more subsets of the set of air-gapped systems' states based on a vectorized set of standard operating procedures in execution at a time of the generating;
determining, using at least one aggregation, an intersystem state event dependency defining the aggregating using natural language processing techniques;
forwarding the intersystem state event dependency to a secondary event aggregator;
classifying the intersystem state event dependency as an abnormal intersystem state event dependency;
determining, based on a historical corpus of intersystem state event dependencies, a resolution for the abnormal intersystem state event dependency; and
implementing the resolution to resolve the abnormal interstate system state event dependency.

9. The system of claim 8, wherein the intersystem state event dependency is classified as normal, further comprising notifying a user of a normal intersystem state event dependency.

10. The system of claim 8, wherein the resolution for the abnormal intersystem state event dependency cannot be determined, further comprising:
localizing, using the set of visual capture devices, one or more root-cause subsystems of the plurality of monitored air-gapped systems; and
notifying one or more users of a locality of the one or more root-cause subsystems.

11. The system of claim 8, wherein the forwarding is performed using a data diode to preserve an air-gapped nature of the air-gapped systems.

12. The system of claim 8, wherein the operations further comprise generating a prompt using a large language model, the prompted based at least in part on the intersystem state event dependency and the historical corpus of intersystem state event dependencies.

13. The system of claim 12, wherein the prompt is based at least in part on an events trend summary and a results of a retrieval-augmented generation operation.

14. The system of claim 8, wherein the operations further comprise clustering the intersystem state event dependency into one of a plurality of clusters, and generating event tags associated with the plurality of clusters.

15. A computer program product for managing air-gapped systems, the computer program product comprising:
a set of one or more computer-readable storage media;
program instructions, collectively stored in the set of one or more storage media, for causing a processor set to perform the following computer operations:
receiving a set of air-gapped systems' states from a plurality of monitored air-gapped systems, the monitoring performed by a set of visual capture devices capable of visualizing one or more consoles associated with the plurality of monitored air-gapped systems;
aggregating one or more subsets of the set of air-gapped systems' states based on a vectorized set of standard operating procedures in execution at a time of the generating;
determining, using at least one aggregation, an intersystem state event dependency defining the aggregating using natural language processing techniques;
forwarding the intersystem state event dependency to a secondary event aggregator;
classifying the intersystem state event dependency as an abnormal intersystem state event dependency;
determining, based on a historical corpus of intersystem state event dependencies, a resolution for the abnormal intersystem state event dependency; and
implementing the resolution to resolve the abnormal interstate system state event dependency.

16. The computer program product of claim 15, wherein the intersystem state event dependency is classified as normal, further comprising notifying a user of a normal intersystem state event dependency.

17. The computer program product of claim 15, wherein the resolution for the abnormal intersystem state event dependency cannot be determined, further comprising:
localizing, using the set of visual capture devices, one or more root-cause subsystems of the plurality of monitored air-gapped systems; and
notifying one or more users of a locality of the one or more root-cause subsystems.

18. The computer program product of claim 15, wherein the forwarding is performed using a data diode to preserve an air-gapped nature of the air-gapped systems.

19. The computer program product of claim 15, wherein the operations further comprise generating a prompt using a large language model, the prompted based at least in part on the intersystem state event dependency and the historical corpus of intersystem state event dependencies.

20. The computer program product of claim 19, wherein the prompt is based at least in part on an events trend summary and a results of a retrieval-augmented generation operation.
